(19) United States
(12) Patent Application Publication
(10) Pub. No.: US 2004/0002883 A1
(43) Pub. Date: Jan. 1, 2004

(54) Method for linking solution-specific method and process deliverables to business-based delivery framework

(76) Inventors: Keith H. Andrews, Plano, TX (US); Michael V. Bassett, Plano, TX (US); Jeanne G. Carey, Lansing, MI (US); Cory C. Claymon, McKinney, TX (US); Judy L. McInturf, Woodlands, TX (US); Thomas M. Schwalbe, Peoria, AZ (US); Dan W. Bertrand, Oxford, MI (US)

Correspondence Address: BAKER & BOTTS, 30 ROCKEFELLER PLAZA, NEW YORK, NY, 10112

(21) Appl. No.: 10/183,073

(22) Filed: Jun. 27, 2002

(51) Int. Cl. G06F 17/60

(52) U.S. Cl. 705/8

(57) ABSTRACT

A method for logically linking one or more service offerings in a single business-delivery framework includes (a) providing a set of supporting deliverables in the business delivery framework according to a set of predetermined requirements; and (b) mapping the service offerings to one or more supporting deliverables from the set of supporting deliverables to logically link the service offerings in the business delivery framework. The mapping may include (i) extracting a set of business features from each of the service offerings; and (ii) associating each service offering to the one or more supporting deliverables by utilizing the extracted set of business features. The mapping may also include evaluating a result of the associating in the business delivery framework to determine if a modification of the supporting deliverables is required and, if so, modifying the supporting deliverables and repeating associating the extracted business features with the generic business definitions.

### BACKGROUND OF INVENTION

1. Field of the Invention

This invention relates to business delivery frameworks. In particular, it relates to a method for logically linking one or more service offerings in a business delivery framework, and a method for providing a client with an integrated business solution.

2. Description of Related Art

Clients are often faced with business problems and opportunities for which they need solutions. The solutions are often complex and require many “capabilities.” Capabilities are the basic tools, processes, products, services and aptitudes owned by the solution provider. In order to provide a solution, clients' needs and requirements must be taken into account, and different capabilities for performing the necessary tasks and satisfying the specific client's needs and requirements may be used. In order to adequately address particular aspects of the recurring business problems, issues and opportunities, capabilities are typically packaged into sellable sets called service offerings.

Each service offering is typically designed to address a particular aspect of the client's problem and incorporates specific intellectual capital. The incorporated intellectual capital includes capability-specific methods and processes, vocabulary, and defined input and output requirements relating to a particular aspect of the client's business opportunity or problem. Since the solution to a client's problem often requires many capabilities to be used, there may be many profoundly different methods, processes and definitions integrated into one business framework. Hence, it is often very difficult to engineer a combined solution for a particular business problem. Furthermore, different clients have different requirements, and the service offerings may frequently change in response to such client requirements as well as to market demands and changes in technology.

Each service offering ordinarily includes a plurality of capabilities and intellectual capital units, each of which, in turn, has one or more input deliverables and one or more output deliverables. The input and output deliverables of different service offerings must be coordinated in a business delivery framework in such a way that the client may understand how different service offerings integrate into the overall solution. The overall solutions, thus, must coordinate between different service offerings, and their input and output deliverables. This coordination is necessary in order to comprehend the adequacy of the relationship between the client's business issues or problems and the suite of service offerings, which are uniquely integrated to address these issues or problems.

Hence, it is desirable to provide a business delivery framework with a common structure that facilitates the integration of multiple service offerings in a single solution. For example, successfully addressing a single business opportunity may require the development of various business framework blocks, such as strategy; identification, creation and deployment of technical solution artifacts; development and delivery of training to employees; and over-all program and project management coordination. Each of these blocks may be a separate service offering or part of a service offering.

Similarly, it is also desirable to effectively address the clients' unique demands and requirements by combining multiple service offerings into a single solution. It is further desirable to coordinate the solutions and, consequently, multiple service offerings in a single business delivery framework. Thus, it is desirable to allow multiple service offerings to be logically linked into a single, client-facing business delivery framework. Accordingly, there is a need for methods and techniques for logically linking service offerings in a single, client-facing business delivery framework.

### SUMMARY OF THE INVENTION

An object of the present invention is to provide a method which allows multiple service offerings to be logically linked in a single, client-facing business delivery framework.

Another object of the present invention is to provide a method for organizing multiple service offerings in a coordinated fashion to successfully address clients' needs and requirements.

Still another object of the present invention is to utilize client-facing supporting deliverables that are defined in technology neutral business terms to logically link service offerings.

Yet another object of the present invention is to map service-offering primary inputs and outputs to supporting deliverables in a single business-delivery framework.

Still another object of the present invention is to provide a one-to-one mapping of service-offering primary inputs and outputs to supporting deliverables in a single business delivery framework.

Another object of the present invention is to provide a one-to-many mapping of service-offering primary inputs and outputs to supporting deliverables in a single business delivery framework.

Yet another object of the present invention is to provide a many-to-one mapping of service-offering primary inputs and outputs to supporting deliverables in a single business delivery framework.

Still another object of the present invention is to provide a many-to-many mapping of service-offering primary inputs and outputs to supporting deliverables in a single business delivery framework.

In order to meet these and other objects which will become apparent with reference to the further disclosure set forth below, the present invention provides a method for logically linking one or more service offerings in a single business-delivery framework. An exemplary method according to the present invention includes the steps of (a) providing a set of supporting deliverables in the business delivery framework according to a set of predetermined rules; and (b) mapping the service offerings to one or more supporting deliverables from the set of supporting deliverables to logically link the service offerings in the business delivery framework.

Advantageously, the mapping step may include the steps of (i) extracting a set of business features from each of the service offerings; and (ii) associating the extracted set of business features with the one or more supporting deliverables.

Preferably, each extracted business feature is associated with one or more generic business definitions corresponding to the one or more supporting deliverables.

The mapping may also include evaluating a result of the associating step in the business delivery framework to determine if a modification of the supporting deliverables is required and, if so, modifying the supporting deliverables and repeating the step of associating the extracted business features with the generic business definitions.

The supporting deliverables may further be combined to form one or more major client-facing deliverables. The client, then, may be enabled to review the major client-facing deliverables.

Each service offering may include, e.g., capabilities that have at least one primary input deliverable and at least one primary output deliverable. Mapping of the service offerings includes mapping the primary input and output deliverables to the supporting deliverables. Mapping may be, e.g., one-to-one, one-to-many, many-to-one, or a combination thereof. The actual mapping is accomplished by using a generic business definition for each supporting deliverable and associating therewith the business features (representing intellectual capital) extracted from primary input and output deliverables.

In a preferred embodiment, the method for logically linking service offerings in a business delivery framework further includes updating the set of supporting deliverables in the business delivery framework.

Advantageously, the updating may include: (i) determining a set of required supporting deliverable changes by utilizing a set of pre-determined parameters, and (ii) modifying the set of supporting deliverables based on the set of required supporting deliverable changes.

Preferably, the method further includes re-mapping, after updating, the service offerings to the modified set of supporting deliverables in the business delivery framework.

The present invention provides a novel way of mapping intellectual capital from multiple service offerings into a single business delivery framework, thus enabling multiple service offerings to “understand” where mutual integration points exist, and permitting a design and delivery of an integrated business solution that combines multiple intellectual capital content expressed in business terms to address the clients' needs and requirements.

As previously indicated, each service offering has at least one primary input deliverable and at least one primary output deliverable. In a preferred embodiment, logical linking is accomplished by determining the primary input and output deliverables for each service offering, and mapping each primary input and output deliverable to one or more corresponding supporting deliverables. The corresponding supporting deliverables are identified from a set of supporting deliverables provided in the business delivery framework.

The points where primary input and/or output deliverables from two or more service offerings map to the same supporting deliverable in the framework are referred to as integration points among and between service offerings. These integration points contribute to the insight required to logically combine multiple offerings in an integrated business solution.

In a method for logically linking one or more service offerings in a business delivery framework, having the steps of: (a) providing a set of supporting deliverables in the business delivery framework according to a set of predetermined requirements; and (b) mapping the one or more service offerings to one or more supporting deliverables to logically link the service offerings in the business delivery framework, a method for providing a client with an integrated business solution includes the steps of: (i) receiving a set of client requirements; (ii) identifying one or more supporting deliverables from the set of supporting deliverables based on the set of client requirements; (iii) determining one or more service offerings associated with the one or more identified supporting deliverables; and (iv) coordinating the determined service offerings in an integrated business solution.

Preferably, the coordinating step may include analyzing gaps and overlaps in the mapping. The coordinating step may also include rationalizing the integrated business solution based on a result of the mapping analysis. Advantageously, the integrated business solution may also be documented for client's review.

The accompanying drawings, which are incorporated and constitute part of this disclosure, illustrate an exemplary embodiment of the invention and serve to explain the principles of the invention.

### BRIEF DESCRIPTION OF THE DRAWINGS

FIG. 1 is an illustrative diagram presenting a logical linking of service-offering primary input and output deliverables to supporting deliverables in a single business delivery framework.

FIGS. 2(a)-(f) are business framework phase blocks presenting an exemplary multi-level hierarchy of supporting and major client-facing deliverables which are defined in technology neutral business terms.

FIGS. 3(a) is a flow diagram presenting an exemplary method for logically linking one or more service offerings in a business delivery framework according to one aspect of the present invention.

FIG. 3(b) is a flow diagram illustrating a step of updating the business delivery framework according to the method of FIG. 3(a).

FIG. 4 is a flow diagram of an exemplary method for providing a client with an integrated business solution, according to another aspect of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE DRAWINGS

The present invention is directed to a method for logically linking intellectual capital from one or more service offerings in a business delivery framework by mapping each of the service-offering primary input and output deliverables with one or more pre-defined supporting deliverables.

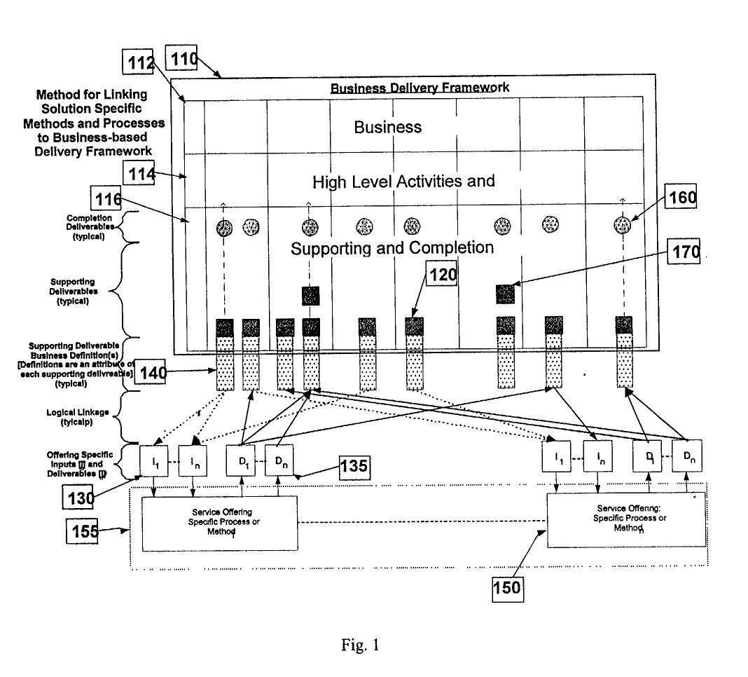

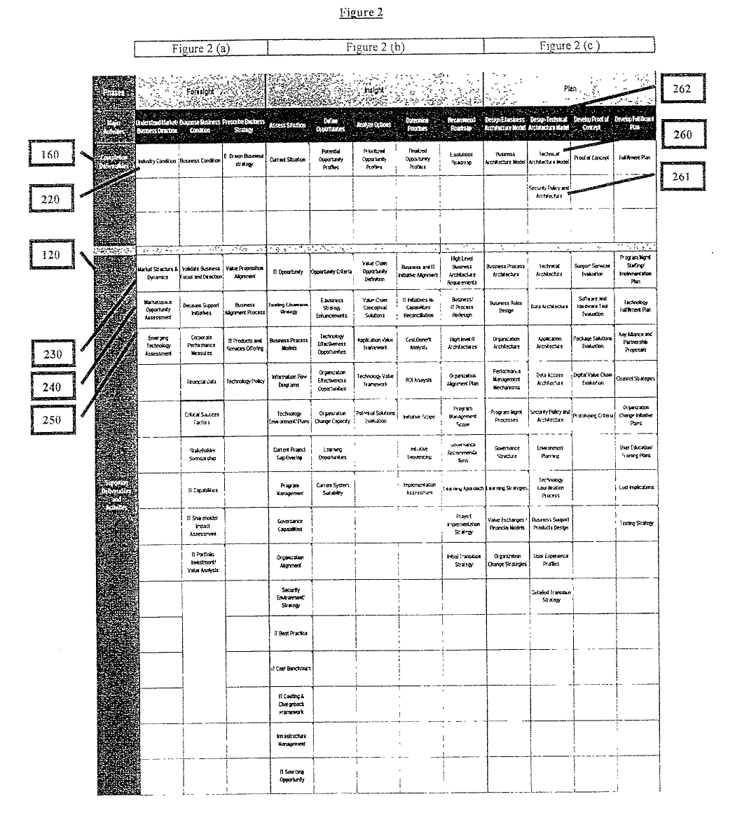

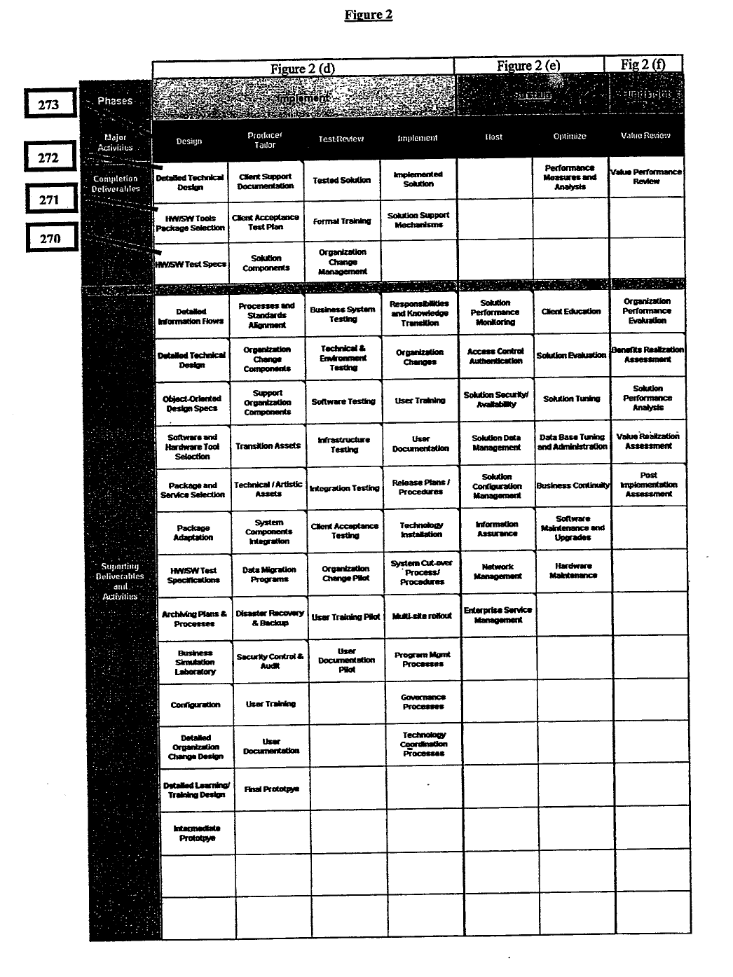

Referring to FIG. 1, a diagram of an exemplary business delivery framework 110 is illustrated. The business delivery framework 110 has a hierarchical structure with several hierarchical levels and several business framework phases. An exemplary set of hierarchical levels in the business delivery framework includes an executive oversight level 112, a client level 114 and a delivery level 116. An exemplary set of phases in the business delivery framework 110 includes “foresight,” “insight,” “plan,” “implement,” “sustain” and “hindsight” phases. (See FIGS. 2(a)-2(f)). Other hierarchical structures may be used without departing from the spirit and scope of the present invention.

The executive oversight level 112 refers to the client's business reviews of the delivery process. An example of a client's business review at this level is a Business Assurance Review. This review is conducted periodically, and represents a communication between the client and service provider executives who have oversight over the solution delivery. The Business Assurance Review includes a review of overall objectives and evaluation of the delivered solution.

The client level 114 represents the level at which the client actively participates in the business framework 110. At this level, the client receives major deliverables 160 from the delivery level 116, the major deliverables 160 representing certain high-level or major activities which are pre-determined to be approved by the client in the business framework 110. Each phase in the business delivery framework 110 may have one or more major activities at the client level 114. Each major activity, in turn, corresponds to one or more major deliverables received from the delivery level 116. Each major deliverable further corresponds to a set of supporting deliverables 120 at the delivery level 116.

The delivery level 116 may contain a multi-level hierarchy of supporting and major client-facing deliverables that are defined in technology neutral business terms, whereby each level in the hierarchy includes as a set the deliverables from the next level, as shown in FIGS. 2(a)-(f).

Referring to FIG. 2(a), an exemplary “foresight” phase in the business delivery framework 110 is illustrated. The exemplary high-level activities pertaining to this phase include Understand Market Business Direction, Diagnose Business Condition and Prescribe Business Strategy. An exemplary set of major deliverables 160, which correspond to these high-level activities includes Industry Condition 220, Business Condition 221, and E-driven Business Strategy 222. Each of these major deliverables further corresponds to a particular set of supporting deliverables 120.

For example, Industry Condition 220 corresponds to the following set of supporting deliverables: Market Structure and Dynamics 230, Marketspace Opportunity Assessment 240, and Emerging Technology Assessment 250. Similarly, Business Condition 221 and E-Driven Business Strategy 222 also have the corresponding sets of supporting deliverables (see FIG. 2(a)).

Referring to FIGS. 2(b)-2(f), each of the remaining phases also has a corresponding set of high-level activities, which, in turn, correspond to one or more major deliverables 160, each of which further corresponds to a set of supporting deliverables 120. For example, the major deliverables Technical Architecture Model 260 and Security Policy Architecture 261 correspond to a high-level activity Design Technical Architecture Model 262. (See FIG. 2(c)). Similarly, the major deliverables HW/SW Test Specs 270, HW/SW Tools Package Selection 271 and Detailed Technical Design 272 correspond to a high-level activity Design 273.

Supporting deliverables 120 are the most detailed deliverables in the business delivery framework. Each supporting deliverable 120 is described in general business terms by using a generic business definition. Supporting deliverables 120 serve two purposes: they are an object in the delivery framework 110 where service-offering intellectual capital is mapped, and they also combine in sets to create the content of one or more major deliverables 160.

As previously indicated, the major deliverable Industry Condition 220 (FIG. 2(a)) includes as a set the supporting deliverables from the lower level, namely, Market Structure and Dynamics 230, Market-Space Opportunity Assessment 240, and Emerging Technology Assessment 250. Other exemplary major deliverables 160 and supporting deliverables 120 are also disclosed in FIGS. 2(a)-(f).

The major deliverables 160 are delivered to the client through the hierarchical levels of the business delivery framework 110 for review and sign-off at the client level 114.

Referring back to FIG. 1, each service offering may have a plurality of service capabilities (not shown). Each service capability, in turn, may have a plurality of methods and processes, in other words, a substantial intellectual capital. In order to map a particular service capability, and, consequently, a service offering, in the business delivery framework 110, offering-specific intellectual capital units ICU₁₋ₙ 150 are first identified. In one embodiment of the present invention, this is accomplished by human operators. The offering-specific intellectual capital units 150 may include a plurality of specific methods, processes, vocabulary, and client-specific input and output deliverable requirements.

Then, one or more primary input deliverables 130 and one or more primary output deliverables 135 may be ascertained for each intellectual capital unit ICU₁₋ₙ, and consequently for each capability, in a particular service offering. It must be noted that the primary input deliverables 130 may be provided by a client, or they also may be an output of another intellectual capital unit, capability or offering. For example, an inventory of the client's business processes is a primary input deliverable which is often produced by the client. Also, the client is often required to delineate their technology policies as primary input deliverables. However, the technology policy, for example, may also be obtained as an output of another offering, capability or a process, namely, as a primary output deliverable 135. Therefore, service offerings may include the primary input deliverables 130 as well as primary output deliverables 135, namely, the results of a subset offering, capability, process or method.

An exemplary service offering 155 is “EDS Strategic Business and IT Planning.” This commercially available service offering develops a strategic enterprise architecture utilizing a mature multi-phase methodology. One of such phases, i.e. capabilities, is Develop Enterprise Architecture, in which six distinct activities, i.e., methods and processes, assess and analyze primary input deliverables. Some examples of primary input deliverables include Corporate Performance Measures, Financial Data, and Information Technology (IT) Capabilities. These exemplary primary input deliverables contain essential business information necessary for the production of architecture deliverables such as business context, current and target business architectures, technology policy, enterprise IT architectures, and transition plans.

Corporate Performance Measures (CPM) is an exemplary primary input deliverable that identifies how others measure the client's organization and how the client's organization measures itself. CPM further identifies gaps and/or disconnects in key performance indicators. Financial Data is another exemplary primary input deliverable that allows for ascertaining context, business conditions and current situations. IT Capabilities is yet another exemplary primary input deliverable which allows for analysis, documentation and/or validation of the client organization's ability to support existing, planned and/or emerging technologies.

Finally, the service-offering primary input deliverables 130 and primary output deliverables 135 are logically linked with the corresponding supporting deliverables 120 in the business delivery framework 110. The actual linkage is accomplished by using a generic business definition 140 associated with each supporting deliverable 120. The generic business definition uses unique and general business terms to describe each supporting deliverable. For example, the supporting deliverable Market Structure and Dynamics 230 (FIG. 2a) has a corresponding exemplary generic business definition: “High Level Description of the Client's Current Market Situation and Business Vision.” Similarly, a generic business definition corresponding to Marketspace Opportunity Assessment 240 is “High Level Identification of Opportunities and Threats Identified Based on Current Market Situation and Business Vision.” Other generic business definitions may be used without departing from the spirit and scope of the present invention.

Using the generic business definitions 140 for supporting deliverables 120, each of the primary input deliverables 130 and primary output deliverables 135 is analyzed, and it is determined if a set of business features corresponding to each generic business definition 140 may be extracted from the deliverable. If a particular set of business features corresponding to a particular generic business definition 140 may be extracted, the primary input deliverable 130 or primary output deliverable 135 is linked with the corresponding supporting deliverable 120. Conversely, if no features may be extracted for a given generic business definition 140, no mapping occurs between that particular primary deliverable and the corresponding supporting deliverable 120.

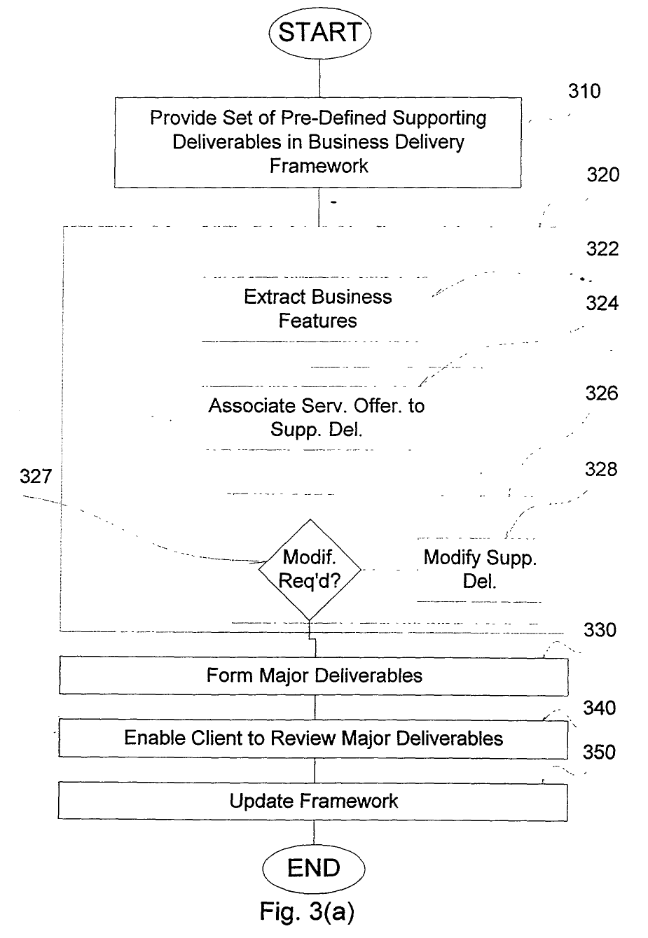

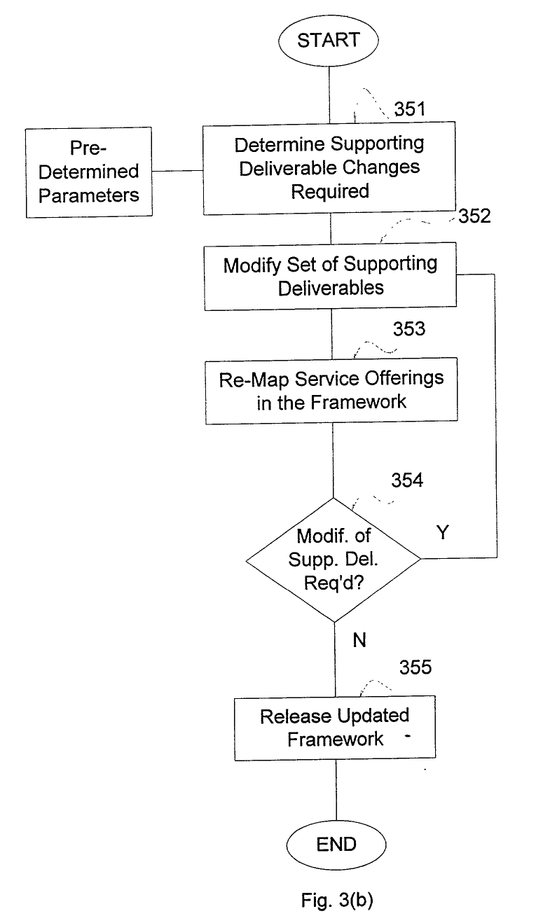

FIG. 3(a) is a flow diagram presenting an exemplary method for logically linking one or more service offerings in a business delivery framework according to one aspect of the present invention. Referring to FIG. 3(a), the method for logically linking service offerings in the business delivery framework is initiated in step 310 of providing a set of supporting deliverables 120 in the business delivery framework 110 according to a set of predetermined rules. The predetermined rules are dependent upon various factors, such as client experiences, market forces, updated offerings, and various other business factors. The providing step 310 may be accomplished, e.g., by human operators.

After the supporting deliverables are provided in the business delivery framework, in step 320, the service offerings are mapped to one or more supporting deliverables 120 from the set of supporting deliverables to logically link the service offerings in the business delivery framework. This step may also be accomplished by human operators, but other alternatives known in the art may be used, e.g., a software program such as the Metis® tool from Computas that has the functionality supporting the construction of logical models from objects and relationships in a business context.

Advantageously, the mapping step 320 may include step 322 of extracting a set of business features from each of the service offerings, and step 324 of associating the extracted set of business features with the one or more supporting deliverables. The extracting step 322 may be accomplished by human operators or by using a software application, such as Metis® mentioned above (if the offering architecture has been captured in a business model). The associating step 324 may be done, e.g., by human operators.

Advantageously, each extracted business feature may be associated with one or more generic business definitions corresponding to the one or more supporting deliverables.

The mapping step 320 may optionally include step 326 of evaluating a result of the associating in the business delivery framework. The evaluating step 326 may further include step 327 of determining if a modification of the supporting deliverables is required and, if so, step 328 of modifying the supporting deliverables. The associating step 324 is then repeated until no modifications of the supporting deliverables are required. The evaluating step 326 may be performed, e.g., by human operators.

One or more supporting deliverables may further be combined in step 330 to form a major client-facing deliverable. The client may also be enabled in step 340 to review the major client-facing deliverables. These steps may be performed, e.g., by human operators. The business delivery framework may finally be updated in step 350.

As previously indicated, each service offering may have, e.g., one or more primary input deliverables and one or more primary output deliverables. Mapping of the service offerings includes mapping the primary input and output deliverables to the supporting deliverables. The mapping between the primary input/output deliverables and the supporting deliverables may take one of several forms: one-to-one, one-to-many many-to-one and many-to-many. One-to-one mapping occurs when one of the primary input deliverables and primary output deliverables is mapped to only one supporting deliverable based on a single generic business definition. For example the delivery of an Information Technology Planning solution will typically request the client's current assessment of emerging technology relative to their industry segment. This input to the planning service would map to Emerging Technology Assessment 250 (FIG. 2(a)). More often, though, the primary deliverables and will fit more than one generic business definition, and, consequently, may be mapped to more than one supporting deliverable. This is referred to as one-to-many mapping.

One-to-many mapping occurs when one of the primary deliverables contains the business features that fall under more than one generic business definition. In other words, one-to many mapping occurs when the primary deliverable may be linked to more than one supporting deliverable. For example, the previously mentioned, commercially available, EDS Strategic Business and Information Technology Planning offering 155 produces an output deliverable called Current State Analysis, which in a typical client engagement maps to the framework supporting deliverables Existing Business Strategy (the strategic direction (two to three years) of the business infrastructure as it pertains to the overall customer's business direction), Technology Environment (high-level description and assessment of current technology environment and plans) and Infrastructure Management (refers to both IT infrastructure (HW, SW and computer -related communications that support the ongoing provision of the IT service and/or organizational infrastructure (management, organization, finance))) (see FIG. 2(b)).

Many-to-one mapping occurs when a plurality of primary input/output deliverables have similar business features that may fall under the same generic business definition representing a particular contributory deliverable. In other words, a many-to-one mapping occurs when more than one of the primary input/output deliverables may be logically linked to the same contributory deliverable. For example, the EDS Strategic Business and Information Technology Planning offering produces a set of recommendation deliverables that typically include a definition of integrated business and IT projects, a business value impact analysis for the projects, a prioritization of the projects, and a transition plan. This entire set can be mapped to the supporting deliverable Initial Transition Strategy (see FIG. 2(b)) (Grouping of change initiatives into major projects and providing the high level implementation plan required to move the organization from the current to a future state) It must be noted that there may be one or more supporting deliverables onto which no primary input or output deliverable from a particular solution, offering, capability, method or process may be mapped. Such a non-mapped supporting deliverable 170 is shown in FIG. 1. The non-mapped supporting deliverable 170 represents unused intellectual capital from the capabilities which are not used in this particular solution. However, should such capabilities be necessary, the primary input deliverables 130 and primary output deliverables 135 from such capability would be mapped to this particular supporting deliverable 170.

The mapping also may be used to enable the user to understand how multiple offerings, different capabilities, and processes or methods are intertwined and related to each other. Each solution, offering, capability, method or process has a set of input deliverables 130 and a set of output deliverables 135. These input and output deliverables may be related to each other. For example, an offering-specific process or method n (ICU 150) (FIG. 1) may be related to an offering-specific process or method 1 (ICU 150) (FIG. 1) in such a way that an input of process n relates to an output of process 1. However, it may be extremely hard for the client to understand that these two processes or methods are related to each other, and see how they are related. When these input and output deliverables are logically linked with the supporting deliverables 120 through the corresponding generic business definitions 140, it becomes easy for the client to understand that the output deliverable D₁ of the offering-specific process or method 1 (ICU 150) is related to an input Iₙ of the offering-specific process or method n (ICU 150). The business delivery framework 110 and its logical linking scheme helps the client understand how these different offerings, capabilities, methods or processes are related to each other.

As previously indicated with reference to FIG. 3(a), the business delivery framework 110 is periodically updated in step 350. The step 350 of updating the business delivery framework is described in more detail with reference to FIG. 3(b).

Referring to FIG. 3(b), the step 350 of updating the business delivery framework begins with step 351 of determining a set of required supporting deliverable changes based on a set of predetermined parameters. The set of predetermined parameters may include, e.g., client experiences, market forces, updated offerings, etc. Subsequently, in step 352, the set of supporting deliverables is modified based on the set of required supporting deliverable changes. The service offerings may then be re-mapped in step 353 to one or more supporting deliverables from the modified set of supporting deliverables to logically link the service offerings in the updated business delivery framework.

After the service offerings and the corresponding intellectual capital are remapped, it is determined, in step 354 whether additional modifications of supporting deliverables are necessary, and if so, step 352 is repeated until no additional modifications are needed. Subsequently, in step 355, the updated business delivery framework is released and used to provide a client with an integrated business solution.

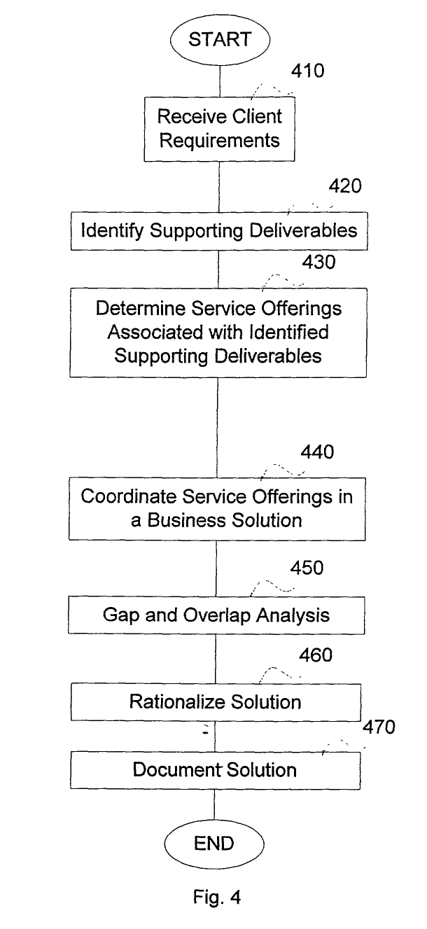

Referring now to FIG. 4, a flow diagram of an exemplary method for providing a client with an integrated business solution according to another aspect of the present invention is illustrated. This method is initiated in step 410 of receiving a set of client requirements. The client requirements relate to what the client demands from an integrated business solution for a particular problem or business opportunity. For example, the client may demand that certain aspects of the business problem or opportunity be performed by a solution provider. Based on these requirements, in step 420, one or more supporting deliverables are identified in a business delivery framework, which correspond to the set of client requirements. As previously indicated, each service offering is mapped in the business delivery framework to one or more supporting deliverables. After the supporting deliverables which correspond to the set of client requirements have been identified, one or more service offerings associated with the identified supporting deliverables are determined in step 430. This step may be performed by human operators, or it may be done automatically, by using a software application such as the Metis® tool previously described.

Once all the associated service offerings are determined, they are coordinated, in step 440, in an integrated business solution. In other words, all the determined service offerings are coordinated and a unique business solution, which best addresses the client requirements, is provided to the client.

Optionally, gaps and overlaps in the integrated business solution may be analyzed in step 450. As previously pointed out, various service offerings may get mapped to a particular supporting deliverable, and, conversely, one service offering may get mapped to a plurality of supporting deliverables. In case where two or more service offerings are mapped to a particular supporting deliverable, that point is referred to as an integration point, and the two service offerings overlap. Of course, there also may be situations where no service offerings are mapped to a particular supporting deliverable identified based on the client requirements. In other words, there may be some input deliverables that are not mapped, and for which there is no corresponding method or process provided by the service provider. In that case, there is a gap in the business solution. In case where gaps and overlaps exist, they may be analyzed so that a meaningful business solution can be provided to a client.

For example, a supporting deliverable Detailed Technical Design 272 (FIG. 2(d)) has a corresponding business definition: “Design specifications are a blueprint of business procedures to provide the structure and detail so that they can be converted (coded) into an application system or its components (modules). This blueprint details and conforms to other external constraints such as technology standards and technical and data platform constraints.” In the design of a complex solution for a client, it is possible for more than one offering to map one (or more) of their deliverables to Detailed Technical Design. When this occurs, further analysis of the offering deliverables typically reveals differences in the participating offerings' scope and granularity. For example, the technical design specifications for a Client Relationship Management, which involve the integration of complex commercially available packaged software into the business, may have significantly different design specifications than those delivered as a precursor to the development of a internet based retail catalog application.

The analyzing may be performed, e.g., by human operators, using the standard business techniques. After such an analysis is performed, in step 460, the solution is rationalized, so that it can be provided to the client. The rationalization may include, e.g., adapting the existing capabilities, methods and processes to cover the gaps, and determining which of the overlapping service offerings better fits in a particular business solution. The rationalized solution may, then, be documented in step 470 for client's review.

The foregoing illustrates the principles of the invention. Various modifications and alterations to the described embodiments will be apparent to those skilled in the art in view of the teachings herein. It will thus be appreciated that those skilled in the art will be able to devise numerous techniques which, although not explicitly shown or described herein, embody the principles of the invention and are thus within the spirit and scope of the invention

What is claimed is:

1. A method for logically linking one or more service offerings in a business delivery framework, comprising the steps of:
a) providing a set of supporting deliverables in said business delivery framework according to a set of predetermined requirements;
b) mapping said one or more service offerings to one or more supporting deliverables from said set of supporting deliverables to logically link said one or more service offerings in said business delivery framework.

2. The method of claim 1, wherein said providing step is accomplished by human operators.

3. The method of claim 1, wherein each supporting deliverable comprises a generic business definition.

4. The method of claim 3, wherein said mapping step comprises the steps of:
(i) extracting a set of business features from each of said one or more of service offerings; and
(ii) associating each service offering to said one or more supporting deliverables by utilizing said set of business features.

5. The method of claim 4, wherein said extracting comprises:
(A) identifying one or more intellectual capital units in said service offering;
(B) for each identified intellectual capital unit, ascertaining at least one primary input deliverable and at least one primary output deliverable; and
(C) utilizing said generic business definitions to extract one or more business features from said at least one primary input deliverable and at least one primary output deliverable.

6. The method of claim 5, wherein said associating comprises associating each of said at least one primary input deliverable and said at least one primary output deliverable to said one or more supporting deliverables.

7. The method of claim 5, wherein said extracting step is accomplished manually by human operators.

8. The method of claim 5, wherein said associating comprises associating each of said at least one primary input deliverable and said at least one primary output deliverable to one or more generic business definitions corresponding to said one or more supporting deliverables.

9. The method of claim 9, wherein said mapping comprises evaluating a result of said associating in the business delivery framework.

10. The method of claim 8, wherein said evaluating comprises:
(i) determining if a modification of said set of supporting deliverables is required by using a result of said associating; and
(ii) if a modification of said set of supporting deliverables is required,
1. modifying said set of supporting deliverables; and
2. repeating said associating.

11. The method of claim 1, wherein each of said one or more service offerings comprises at least one primary input deliverable and at least one primary output deliverable, and wherein said mapping comprises mapping each of said at least one primary input deliverable and said at least one primary output deliverable to said one or more supporting deliverables.

12. The method of claim 1, wherein said mapping is a one-to-one mapping.

13. The method of claim 1, wherein said mapping is a one-to-many mapping.

14. The method of claim 1, wherein said mapping is a many-to-one mapping.

15. The method of claim 1, wherein said mapping is a many-to-many mapping.

16. The method of claim 1, further comprising the step of combining one or more supporting deliverables from said set of supporting deliverables to form one or more major client-facing deliverables.

17. The method of claim 16, further comprising enabling a client to review said one or more major client-facing deliverables.

18. The method of claim 1, further comprising the step of periodically updating said set of supporting deliverables in said business delivery framework.

19. The method of claim 18, wherein said updating comprises determining a set of required supporting deliverable changes based on a set of predetermined parameters.

20. The method of claim 19, wherein said updating comprises modifying said set of supporting deliverables based on said set of required supporting deliverable changes.

21. The method of claim 20, further comprising re-mapping said one or more service offerings to one or more supporting deliverables from said modified set of supporting deliverables to logically link said one or more service offerings in said business delivery framework.

22. In a method for logically linking one or more service offerings in a business delivery framework, comprising the steps of:
a) providing a set of supporting deliverables in said business delivery framework according to a set of predetermined requirements; and
b) mapping said one or more service offerings to one or more supporting deliverables from said set of supporting deliverables to logically link said one or more service offerings in said business delivery framework, a method for providing a client with an integrated business solution, comprising the steps of:
(i) receiving a set of client requirements;
(ii) identifying one or more supporting deliverables from said set of supporting deliverables based on said set of client requirements;
(iii) determining one or more service offerings associated with said one or more identified supporting deliverables; and
(iv) coordinating said determined service offerings in an integrated business solution.

23. The method of claim 22, wherein said coordinating comprises analyzing gaps and/or overlaps in said mapping of said one or more service offerings.

24. The method of claim 23, wherein said coordinating comprises rationalizing said integrated business solution based on a result of said analyzing.

25. The method of claim 24, further comprising documenting said integrated business solution.
